(19) United States
(12) Patent Application Publication
(10) Pub. No.: US 2026/0053148 A1
(43) Pub. Date: Feb. 26, 2026

(54) A Method for Preparing a Baked Product with Reduced Fat

(71) Applicant: Novozymes A/S, Bagsvaerd (DK)

(72) Inventors: Jusci KUMAR, Bangalore (IN); Sajid AKBAR, New South Walke (AU)

(73) Assignee: Novozymes A/S, Bagsvaerd (DK)

(21) Appl. No.: 19/105,481

(22) PCT Filed: Sep. 8, 2023
(86) PCT No.: PCT/EP2023/074736

§ 371 Date: Feb. 21, 2025

(30) Foreign Application Priority Data
Sep. 8, 2022 (IN) 202241051427

(51) Int. Cl. A21D 8/04; A21D 2/18; A21D 13/068; A21D 13/80

(52) U.S. Cl. CPC A21D 8/042; A21D 2/181; A21D 13/068; A21D 13/80

(57) ABSTRACT

The present invention relates to methods, uses and products for preparing a baked product comprising reduced fat. The method comprises steps of a) preparing a dough with one or more lipases or/and one or more proteases, b) moulding and/or sheeting the dough and c) baking the dough. The baked product is selected from a group consisting of biscuits, cookies, 5 and crackers. The baked product has at least 10-25 wt. % fat reduced when compared to a baked product prepared without the one or more lipases or/and one or more proteases.

### REFERENCE TO SEQUENCE LISTING

This application contains a Sequence Listing in computer readable form. The computer readable form is incorporated herein by reference.

### FIELD OF THE INVENTION

The present invention relates to a method for preparing a baked product. The present invention particularly relates to a method for preparing a baked product comprising reduced fat.

### BACKGROUND

The bakery industry is one of the biggest industries within the food processing sector, and biscuit industry is the largest segment in bakery industry because of its nutrition profile, ready to eat product, rich in energy, excellent source of supplement diet, easy to digest and highly hygienic. Typically, the base ingredients of biscuits and cookies are flour, oil, and sugar. Other ingredients can vary depending on the type of biscuit or cookie and the recipe followed. Most biscuits and cookies are high in fat and calories. Currently, a great consideration is given to the contribution of commercially baked biscuits and cookies on growing levels of obesity, especially child obesity. The industry is focusing on providing commercially baked biscuits and cookies with lower calorie content by simply reducing the fat content and/or the sugar content in the biscuits or cookies formulation. When the fat content is reduced in the recipe, the baked biscuits and cookies are drier, crumblier, have otherwise unacceptable properties and may have shorter shelf-life.

The fat constituent of any dough acts to lubricate the dough, to extend the shelf life of the commercially baked biscuits and cookies, as well as to improve the texture of the biscuits and cookies. The shelf life of commercially baked biscuits and cookies is primarily extended by lubricating and spreading the fats throughout the dough to coat the sugar constituents of the dough, thereby precluding the ingress of air to the sugar constituents. However, when the fat content is reduced, the ability of the remaining fat constituent to spread and coat the sugar is also reduced.

In addition, the cost of different types of oils, such as soybean oil, palm oil, sunflower oil, rapeseed oil, safflower oil, corn oil, or cottonseed oil used in baking is rising due to various reasons. By reducing the amount of oil used in baking biscuits and cookies, the overall price of manufacturing the biscuits and cookies can be reduced.

Using organically derived phospholipid, emulsifiers, or modified starch in baking biscuits and cookies is known from the prior art, but such alternatives are used in high quantity approximately 3% or more. Such alternatives are expensive and also the texture, mouthfeel, taste of baked biscuits and cookies are compromised.

Thus, there is a need to reduce fat and/or sugar content in the baked biscuits and cookies cost effectively without compromising the flavor, texture and desirable taste.

### SUMMARY OF THE CLAIMED INVENTION

The present invention relates to a method for preparing a baked product.

In one aspect, the present invention relates to a method for preparing a baked product comprising reduced fat. The method comprises steps of a) preparing a dough with one or more lipases or/and one or more proteases, b) molding and/or sheeting the dough and c) baking the dough. The baked product is selected from a group consisting of biscuits, cookies, laminated variant of biscuits, and crackers.

In another aspect, the present invention relates to use of one or more lipases or/and one or more proteases in the production of a baked product to reduce fats and/or sugars used in a recipe of making the baked product.

In yet another aspect, the present invention relates to a baked product with reduced fat obtained by preparing dough with one or more lipases or/and one or more proteases.

### Overview of Sequence Listing

SEQ ID NO:1 is mature amino acid sequence of 1,3 lipase derived from Thermomyces lanuginosus.

SEQ ID NO:2 is mature amino acid sequence of phospholipase derived from Fusarium oxysporum.

SEQ ID NO:3 is mature amino acid sequence of phospholipase derived from Thermomyces lanuginosus.

SEQ ID NO:4 is mature amino acid sequence of phospholipase derived from Thermomyces lanuginosus.

SEQ ID NO:5 is mature amino acid sequence of alpha amylase derived from Aspergillus oryzae

SEQ ID NO:6 is mature amino acid sequence of protease derived from Bacillus amyloliquefaciens

SEQ ID NO:7 is mature amino acid sequence of xylanase derived from Thermomyces lanuginosus

SEQ ID NO:8 is mature amino acid sequence of protease derived from Nocardiopsis prasina

SEQ ID NO:9 is mature amino acid sequence of protease derived from Bacillus licheniformis

SEQ ID NO:10 is mature amino acid sequence of protease derived from Fusarium oxysporum

SEQ ID NO:11 is mature amino acid sequence of protease derived from Aspergillus oryzae

SEQ ID NO:12 is mature amino acid sequence of protease derived from Aspergillus oryzae

### BRIEF DESCRIPTION OF THE DRAWINGS

A more complete understanding of the present invention may be derived by referring to the detailed description and claims when considered in connection with the Figures.

FIG. 1 represents a graph that demonstrates the effect of low amount of lipase on spread factor and height factor of butter cookies compared to the effect of higher quantity of phospholipases on cookies.

FIG. 2 shows texture of butter cookies with 10% fat reduction in samples of negative control and trial with lipase.

FIG. 3 shows texture of butter cookies with 20% fat reduction in samples of negative control and trial with lipase.

FIG. 4 shows slight increase in stack height of butter cookies with 25% fat reduction in samples of positive control and trial with lipase and protease.

FIG. 5 shows shrinkage and hardness of laminated variant of biscuits with 10% fat reduction in samples of negative control over positive control and trial with lipase and protease.

FIG. 6 shows stack height of laminated variant of biscuits with 10% fat reduction in samples of negative control and trial with lipase and protease.

### DEFINITIONS

The disclosed embodiments relate to methods, uses and products for preparing a baked product comprising reduced fat.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. For the sake of brevity and/or clarity, well-known functions or constructions may not be described in detail.

As used herein, the singular forms “a,” “an,” and “the” are intended to include the plural forms as well, unless the context clearly indicates otherwise.

Throughout this disclosure, unless the context requires otherwise, the words “comprise,” “comprises,” and “comprising” will be understood to imply the inclusion of a stated step or element or group of steps or elements but not the exclusion of any other step or element or group of steps or elements.

The term “consisting of” means including, and limited to, whatever follows the phrase “consisting of.” Thus, the phrase “consisting of” indicates that the listed elements are required or mandatory, and that no other elements may be present. The term “consisting essentially of” means including any elements listed after the phrase and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

As used herein, the term lipase is 1, 3 specific lipase which acts only on triglycerides.

As used herein, the term fat reduction is using less amount of fats in preparing dough for a baked product such as biscuits, cookies, laminated variant of biscuits, and/or cracker.

For purposes of the present invention, the sequence identity between two amino acid sequences is determined as the output of “longest identity” using the Needleman-Wunsch algorithm (Needleman and Wunsch, 1970, J. Mol. Biol. 48:443-453) as implemented in the Needle program of the EMBOSS package (EMBOSS: The European Molecular Biology Open Software Suite, Rice et al., 2000, Trends Genet. 16:276-277), preferably version 6.6.0 or later. The parameters used are a gap open penalty of 10, a gap extension penalty of 0.5, and the EBLOSUM62 (EMBOSS version of BLOSUM62) substitution matrix. In order for the Needle program to report the longest identity, the no brief option must be specified in the command line. The output of Needle labeled “longest identity” is calculated as follows:

$$( Identical Deoxyribonucleotides \times 100 ) / ( Length of Alignment - Total Number of Gaps in Alignment )$$

For purposes of the present invention, the sequence identity between two polynucleotide sequences is determined as the output of “longest identity” using the Needleman-Wunsch algorithm (Needleman and Wunsch, 1970, supra) as implemented in the Needle program of the EMBOSS package (EMBOSS: The European Molecular Biology Open Software Suite, Rice et al., 2000, supra), preferably version 6.6.0 or later. The parameters used are a gap open penalty of 10, a gap extension penalty of 0.5, and the EDNAFULL (EMBOSS version of NCBI NUC4.4) substitution matrix. In order for the Needle program to report the longest identity, the no brief option must be specified in the command line. The output of Needle labeled “longest identity” is calculated as follows:

$$( Identical Residues \times 100 ) / ( Length of Alignment - Total Number of Gaps in Alignment )$$

While certain aspects of the present disclosure will hereinafter be described with reference to embodiments thereof, it will be understood by those of ordinary skill in the art that various changes in form and details may be made therein without departing from the spirit and scope of the present invention as defined by the claims.

### DETAILED DESCRIPTION OF THE INVENTION

The present invention relates to methods, uses and products for preparing a baked product comprising reduced fat.

In order to provide reduced fat in a baked products such as, but not limited to, biscuits, cookies, laminated variant of biscuits, or cracker, the inventors identified that adding one or more lipases in small amount (in parts per million) while preparing the dough for a baked product and reducing 10-25% fats in the dough by replacing the reduced fats with flour provides baked products with same or improved qualities or properties such as texture, dough property, dimensions, mouthfeel, balanced flavors/aroma, etc. of the baked product. The one or more lipases act as emulsifying agent which is added to the dough in a small quantity compared to other commercially known emulsifiers which are required to be added in higher amount (3-5 weight percent). In addition, the inventors identified that adding one or more lipases in small amounts while preparing the dough for the baked product and reducing 10-25% fats and 1-5 wt. % of sugars in the dough also does not compromise the qualities or properties of the baked product. Further, the inventors identified that adding one or proteases in small amount (in parts per million) while preparing the dough for a baked product and reducing 10-25% fats in the dough by replacing the reduced fats with flour provides baked products with same or improved baked products with some of qualities or properties such as texture, dough property, dimensions, mouthfeel, balanced flavors/aroma, etc. of the baked product. In one aspect, the present invention relates to a method for preparing a baked product comprises steps of a) preparing a dough with one or more lipases or/and one or more proteases; b) moulding and/or sheeting the dough; and c) baking the dough. The baked product has at least 10 weight percent (wt. %) fat reduced when compared to a baked product prepared without the one or more lipases or/and one or more proteases. In another embodiment, the baked product has at least 20 wt. % of fat reduced compared to a baked product prepared without the one or more lipases or/and one or more proteases. In yet another embodiment, the baked product has at least 25 wt. % of fat reduced compared to a baked product prepared without the one or more lipases or/and one or more proteases. The baked product is selected from a group consisting of biscuits, cookies, laminated variant of biscuits and crackers.

In an embodiment of the present invention, the step of preparing dough comprises adding one or more sugars, one or more flours, one or more lipases or/and one or more proteases and one or more fats. The dough comprises 10 wt. % to 30 wt. % one or more added sugars, preferably 15 wt. % to 25 wt. %, more preferably 20 wt. %. In another embodiment, the baked product has further reduced sugar when compared to a baked product prepared without the one or more lipases or/and one or more proteases. The baked product has 1 wt. % to 5 wt. % sugar reduced when compared to a baked product prepared without the one or more lipases or/and one or more proteases.

In an embodiment of the present invention, the dough for cookies comprises 40 wt. % to 70 wt. % one or more added flours, preferably 55 wt. % to 65 wt. %. The one or more flours is selected from a group consisting of wheat flour, all-purpose flour, whole wheat flour, rice flour, corn flour, millet flour, soya flour, oats flour, pastry flour, bread flour, gluten free flour, tapioca flour and self-rising flour.

In an embodiment of the present invention, the dough for cookies comprises 0.00004 wt. % to 0.0002 wt. % of one or more added lipases, preferably 0.00006 wt. % to 0.0001 wt. %.

In an embodiment of the present invention, the dough comprises 0.4 to 2 milligram (mg) enzyme protein/Kilogram (kg) flour of one or more added lipases, preferably 0.6 to 1 mg enzyme protein/kg flour.

In an embodiment of the present invention, the dough for cookies comprises 20 parts per million (ppm) to 100 ppm one or more added lipases, preferably 25 ppm to 55 ppm. The lipase is Thermomyces lanuginosus (formerly called Humicola lanuginosus) wild type lipase. In a preferred embodiment, the lipase is 1,3 specific lipase which acts only on triglycerides.

In an embodiment of the present invention, the dough for laminated variant of biscuits comprises 0.00001 wt. % to 0.0006 wt. % wt. % of one or more added lipases, preferably 0.000014 wt. % to 0.000016 wt. %

In an embodiment of the present invention, the dough for laminated variant of biscuits comprises 0.1 to 0.6 milligram (mg) enzyme protein/Kilogram (kg) flour of one or more added lipases, preferably 0.14 to 0.16 mg enzyme protein/kg flour.

In an embodiment of the present invention, the dough for laminated variant of biscuits comprises 5 parts per million (ppm) to 30 ppm one or more added lipases.

In an embodiment of the present invention, the one or more lipases is polypeptide selected from the group consisting of:
(a) a polypeptide having at least 80% sequence identity to SEQ ID NO:1,
(b) a polypeptide derived from SEQ ID NO:1 by having 1-30 alterations e.g., substitutions, deletions and/or insertions at one or more positions, e.g., 1 or 2 or 3 or 4 or 5 or 6 or 7 or 8 or 9 or 10 or 11 or 12 or 13 or 14 or 15 or 16 or 17 or 18 or 19 or 20 or 21 or 22 or 23 or 24 or 25 or 26 or 27 or 28 or 29 or 30 alterations, in particular substitutions,
(c) a polypeptide derived from the polypeptide of (a), wherein the N- and/or C-terminal end has been extended by addition of one or more amino acids, and
(d) a fragment of the polypeptide of (a).

In another embodiment, the polypeptide has at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO:1.

In a preferred embodiment of the present invention, the lipase is a polypeptide comprising, consisting essentially of, or consisting of SEQ ID NO: 1.

In an embodiment, the polypeptide may have an N-terminal and/or C-terminal extension of one or more amino acids, e.g., 1-5 amino acids.

In another aspect, the polypeptide is derived from SEQ ID NO: 1 by substitution, deletion or addition of one or several amino acids. In another aspect, the polypeptide is derived from a mature polypeptide of SEQ ID NO: 1 by substitution, deletion or addition of one or several amino acids. In some embodiments, the polypeptide is a variant of SEQ ID NO: 1 comprising a substitution, deletion, and/or insertion at one or more positions. In one aspect, the number of amino acid substitutions, deletions and/or insertions introduced into the polypeptide of SEQ ID NO: 1 is up to 15, e.g., 1, 2, 3, 4, 5, 6, 7, 8, 9, 10, 11, 12, 13, 14, or 15. The amino acid changes may be of a minor nature, that is conservative amino acid substitutions or insertions that do not significantly affect the folding and/or activity of the protein; small deletions, typically of 1-30 amino acids; small amino or carboxyl-terminal extensions, such as an amino-terminal methionine residue; a small linker peptide of up to 20-25 residues; or a small extension that facilitates purification by changing net charge or another function, such as a poly-histidine tract, an antigenic epitope or a binding module.

In an embodiment of the present invention, the dough comprises 12 wt. % to 35 wt. % one or more fats. The one or more fats is selected from a group consisting of palm oil; palm olein, butter, clarified butter, anhydrous milk fat, corn oil, margarines, olive oil, hydrogenated vegetable fat, sunflower oil, rape-seed oil, rice bran oil, lard, soyabean oil and eggs. In a preferred embodiment, the fat is palm oil or rapeseed oil.

In an embodiment, the step of preparing the dough comprises adding:
i. 10 wt. % to 30 wt. % of one or more sugars,
ii. 40 wt. % to 70 wt. % of one or more flours,
iii. 0.2 wt. % to 2 wt. % of one or more lipases; and
iv. 12 wt. % to 35 wt. % of one or more fats.

In an embodiment, the step of preparing the dough comprises adding:
i. 10 wt. % to 30 wt. % of one or more sugars,
ii. 40 wt. % to 70% wt. % of one or more flours,
iii. 20 ppm to 100 ppm of one or more lipases; and
iv. 12 wt. % to 35 wt. % of one or more fats.

In an embodiment, the step of preparing the dough comprises adding one or more proteases.

In an embodiment of the present invention, the dough for cookies comprises 0. 0.00015 wt % to 0.003 wt % of one or more added proteases, preferably 0.00003 wt % to 0.0006 wt %.

In an embodiment of the present invention, the dough for cookies comprises 1.5 to 30 milligram (mg) enzyme protein/Kilogram (kg) flour of one or more added proteases, preferably 0.3 to 6 mg enzyme protein/kg flour.

In an embodiment of the present invention, the dough for cookies comprises 5 parts per million (ppm) to 100 ppm one or more added proteases.

In an embodiment of the present invention, the dough for laminated variant biscuits comprises 0.00015 wt % to 0.009 wt % of one or more added proteases, preferably 0.00003 wt % to 0.00018 wt %.

In an embodiment of the present invention, the dough for laminated variant biscuits comprises 1.5 to 90 milligram (mg) enzyme protein/Kilogram (kg) flour of one or more added proteases, preferably 0.3 to 18 mg enzyme protein/kg flour.

In an embodiment of the present invention, the dough for laminated variant biscuits comprises 5 parts per million (ppm) to 300 ppm one or more added proteases.

In an embodiment of the present invention, the one or more protease is derived from Bacillus amyloliquefaciens.

In an embodiment of the present invention, the one or more protease is polypeptide selected from the group consisting of:
(a) a polypeptide having at least 80% sequence identity to SEQ ID NO:6,
(b) a polypeptide derived from SEQ ID NO:6 by having 1-30 alterations e.g., substitutions, deletions and/or insertions at one or more positions, e.g., 1 or 2 or 3 or 4 or 5 or 6 or 7 or 8 or 9 or 10 or 11 or 12 or 13 or 14 or 15 or 16 or 17 or 18 or 19 or 20 or 21 or 22 or 23 or 24 or 25 or 26 or 27 or 28 or 29 or 30 alterations, in particular substitutions,
(c) a polypeptide derived from the polypeptide of (a), wherein the N- and/or C-terminal end has been extended by addition of one or more amino acids, and
(d) a fragment of the polypeptide of (a).

In another embodiment, the polypeptide has at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO:6.

In a preferred embodiment of the present invention, the protease is a polypeptide comprising, consisting essentially of, or consisting of SEQ ID NO: 6.

In an embodiment, the polypeptide may have an N-terminal and/or C-terminal extension of one or more amino acids, e.g., 1-5 amino acids.

In another aspect, the polypeptide is derived from SEQ ID NO: 6 by substitution, deletion or addition of one or several amino acids. In another aspect, the polypeptide is derived from a mature polypeptide of SEQ ID NO: 6 by substitution, deletion or addition of one or several amino acids. In some embodiments, the polypeptide is a variant of SEQ ID NO: 6 comprising a substitution, deletion, and/or insertion at one or more positions. In one aspect, the number of amino acid substitutions, deletions and/or insertions introduced into the polypeptide of SEQ ID NO: 6 is up to 15, e.g., 1, 2, 3, 4, 5, 6, 7, 8, 9, 10, 11, 12, 13, 14, or 15. The amino acid changes may be of a minor nature, that is conservative amino acid substitutions or insertions that do not significantly affect the folding and/or activity of the protein; small deletions, typically of 1-30 amino acids; small amino or carboxyl-terminal extensions, such as an amino-terminal methionine residue; a small linker peptide of up to 20-25 residues; or a small extension that facilitates purification by changing net charge or another function, such as a poly-histidine tract, an antigenic epitope or a binding module.

In a further embodiment, the step of preparing the dough comprises adding one or more lipases and one or more proteases in combination.

In another embodiment, the step of preparing the dough comprises adding one or more leavening agents. The dough comprises 0.3 wt. % to 3 wt. % of one or more added leavening agents The leavening agent is selected from a group consisting of sodium bicarbonate, ammonium bicarbonate, sodium acid pyrophosphate (SAPP), sodium phosphate, monocalcium phosphate, sodium aluminium sulfate, potassium bitartrate, sodium aluminium phosphate, glucono-delta-lactone and adipic acid, and combinations thereof.

In yet another embodiment, the step of preparing the dough further comprises adding other ingredients such as invert syrup, salted butter or unsalted butter, lecithin, milk powder, distilled mono and diglycerides (DMG), salt, liquid glucose, cheese, fresh milk, coloring agent, flavoring agent, sodium meta-bisulfate, sweetened condensed milk, spice and condiments, glycerol monostearate (GMS), Diacetyl tartaric acid esters of mono- and diglycerides of fatty acids (DATEM) and/or water.

In an embodiment, the step of preparing the dough includes creaming, mixing and maintaining appropriate temperature for the dough. The one or more flour and the one or more lipases or/and one or more proteases are added during the mixing step while preparing the dough. The resting period is not necessary if the one or more lipases or/and one or more proteases are added during mixing. The present invention improves the dough properties such as dough pH, dough texture, dough temperature and dough sheeting.

In an embodiment, the dough is moulded in one or more dough molds. In another embodiment, the dough is sheeted in one or more sheeters.

In an embodiment, the dough is cut after sheeting/laminating in one or more cutters.

In another embodiment, the sheeted dough is laminated folded one or more times for laminated variant of biscuits.

In an embodiment, the dough is baked in an oven. The oven is selected from a group consisting of a tunnel over, rotary oven and a deck oven. The present invention improves the dimensions of the baked product, e.g., cookies. The dimension can be weight, stack height, average length, average width, volume, density, spread factor, height factor, etc.

In another aspect, the present invention relates to a use of one or more lipases or/and one or more proteases in the production of a baked product to reduce fats and/or sugars using in a preparing the baked product. One or more properties of the baked product is maintained after reducing fats and/or sugars while preparing the dough for the baked product. The one or more properties is selected from a group consisting of mouthfeel, texture, taste, bite, spreadability, color-height-length, volume, moisture, strength, firmness, crunchiness, and shelf-life. The dough of the baked product has at least 10 wt. % reduced fats compared to a baked product prepared without the one or more lipases or/and one or more proteases.

In another aspect, the present invention relates a baked product obtainable by the method as defined in above embodiments or obtained with the use of one or more lipases or/and one or more proteases.

Particular embodiments of the present disclosure are described in the following numbered paragraphs:
1. A method for preparing a baked product comprising reduced fat, the method comprising the steps of:
   a. preparing a dough by adding at least:
   i. one or more sugars,
   ii. one or more flours,
   iii. one or more lipases or/and one or more proteases; and
   iv. one or more fats;
   b. moulding the dough in one or more dough molds and/or sheeting the dough in one or more dough sheeters;
   c. baking the dough;
   wherein the baked product has at least 10 wt. % fat reduced when compared to a baked product prepared without the one or more lipases or/and one or more proteases.
2. The method for preparing the baked product according to paragraph 1, wherein the baked product is selected from a group consisting of biscuits, cookies, laminated variant of biscuits, and crackers.
3. The method for preparing the baked product according to paragraphs 1 or 2, wherein the dough comprises 10 wt. % to 30 wt. % one or more added sugars.
4. The method for preparing the baked product according to any of the preceding paragraphs, wherein the flour is selected from a group consisting of wheat flour, all-purpose flour, whole wheat flour, rice flour, corn flour, millet flour, soya flour, oats flour, pastry flour, bread flour, gluten free flour, tapioca flour and self-rising flour.
5. The method for preparing the baked product according to any of the preceding paragraphs, wherein the dough comprises 40 wt. % to 70 wt. % one or more added flours.
6. The method for preparing the baked product according to any of the preceding paragraphs, wherein the lipase is Thermomyces lanuginosus (formerly called Humicola lanuginosus) wild type lipase.
7. The method for preparing the baked product according to any of the preceding paragraphs, wherein the one or more lipases is a polypeptide selected from a group consisting of:
(a) a polypeptide having at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 1;
(b) a polypeptide derived from SEQ ID NO:1 by having 1-30 alterations e.g., substitutions, deletions and/or insertions at one or more positions, e.g., 1 or 2 or 3 or 4 or 5 or 6 or 7 or 8 or 9 or 10 or 11 or 12 or 13 or 14 or 15 or 16 or 17 or 18 or 19 or 20 or 21 or 22 or 23 or 24 or 25 or 26 or 27 or 28 or 29 or 30 alterations, in particular substitutions;
(c) a polypeptide derived from the polypeptide of (a), wherein the N- and/or C-terminal end has been extended by addition of one or more amino acids; and
(d) a fragment of the polypeptide of (a).
8. The method for preparing the baked product according to any of the preceding paragraphs, wherein the one or more lipases is a polypeptide having a sequence of SEQ ID NO: 1.
9. The method for preparing the baked product according to any of the preceding paragraphs, wherein the dough for cookies comprises 0.00001 wt. % to 0.0002 wt. % one or more added lipases, preferably 0.00006 wt. % to 0.0001 wt. %.
10. The method for preparing the baked product according to any of the preceding paragraphs, wherein the dough for laminated variant of biscuits comprises 0.00001 wt. % to 0.0006 wt. % of one or more added lipases, preferably 0.000014 wt % to 0.000016 wt %.
11. The method for preparing the baked product according to any of the preceding paragraphs, wherein the dough for cookies comprises 0.4 to 2 mg enzyme protein/kg flour of one or more added lipases, preferably 0.6 to 1 mg enzyme protein/kg flour.
12. The method for preparing the baked product according to any of the preceding paragraphs, wherein the dough for laminated variant of biscuits comprises 0.1 to 0.6 mg enzyme protein/kg flour of one or more added lipases, preferably 0.14 to 0.16 mg enzyme protein/kg flour.
13. The method for preparing the baked product according to any of the preceding paragraphs, wherein the dough comprises 20 parts per million (ppm) to 100 ppm one or more added lipases.
14. The method for preparing the baked product according to any of the preceding paragraphs, wherein the dough for laminated variant of biscuits comprises 5 parts per million (ppm) to 30 ppm one or more added lipases.
15. The method for preparing the baked product according to any of the preceding paragraphs, wherein the step of preparing the dough comprises adding one or more proteases.
16. The method for preparing the baked product according to any of the preceding paragraphs, wherein the protease is derived from Bacillus amyloliquefaciens.
17. The method for preparing the baked product according to any of the preceding paragraphs, wherein the one or more proteases is a polypeptide selected from a group consisting of:
(a) a polypeptide having at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 6;
(b) a polypeptide derived from SEQ ID NO:6 by having 1-30 alterations e.g., substitutions, deletions and/or insertions at one or more positions, e.g., 1 or 2 or 3 or 4 or 5 or 6 or 7 or 8 or 9 or 10 or 11 or 12 or 13 or 14 or 15 or 16 or 17 or 18 or 19 or 20 or 21 or 22 or 23 or 24 or 25 or 26 or 27 or 28 or 29 or 30 alterations, in particular substitutions;
(c) a polypeptide derived from the polypeptide of (a), wherein the N- and/or C-terminal end has been extended by addition of one or more amino acids; and
(d) a fragment of the polypeptide of (a).
18. The method for preparing the baked product according to any of the preceding paragraphs, wherein the one or more proteases is a polypeptide having a sequence of SEQ ID NO: 6.
19. The method for preparing the baked product according to any of the preceding paragraphs, wherein the dough for cookies comprises 0.00015 wt % to 0.003 wt % of one or more protease, preferably 0.00003 wt % to 0.0006 wt %.
20. The method for preparing the baked product according to any of the preceding paragraphs, wherein the dough for laminated variant of biscuits comprises 0.00015 wt % to 0.009 wt % of one or more protease, preferably 0.00003 wt % to 0.00018 wt %.
21. The method for preparing the baked product according to any of the preceding paragraphs, wherein the dough for cookies comprises 1.5 to 30 mg enzyme protein/kg flour of one or more added proteases, preferably 0.3 to 0.6 mg enzyme protein/kg flour.
22. The method for preparing the baked product according to any of the preceding paragraphs, wherein the dough for laminated variant of biscuits comprises 1.5 to 90 mg enzyme protein/kg flour of one or more added proteases, preferably 0.3 to 18 mg enzyme protein/kg flour.
23. The method for preparing the baked product according to any of the preceding paragraphs, wherein the dough for cookies comprises 5 parts per million (ppm) to 100 ppm one or more added proteases.
24. The method for preparing the baked product according to any of the preceding paragraphs, wherein the dough for laminated variant of biscuits comprises 5 parts per million (ppm) to 300 ppm one or more added proteases.
25. The method for preparing the baked product according to any of the preceding paragraphs, wherein the step of preparing the dough comprises adding one or more lipases and one or more proteases in combination.
26. The method for preparing the baked product according to any of the preceding paragraphs, wherein the fat is selected from a group consisting of palm oil; palm olein, butter, clarified butter, anhydrous milk fat, corn oil, margarines, olive oil, hydrogenated vegetable fat, sunflower oil, rapeseed oil, rice bran oil, lard, soyabean oil and egg.
27. The method for preparing the baked product according to any of the preceding paragraphs, wherein the fat is palm oil.
28. The method for preparing the baked product according to any of the preceding paragraphs, wherein the dough comprises 12 wt. % to 35 wt. % one or more fats.
29. The method for preparing the baked product according to any of the preceding paragraphs, wherein the step of preparing dough comprises adding:
   i. 10 wt. % to 30 wt. % of one or more sugars,
   ii. 40 wt. % to 70% wt. % of one or more flours,
   iii. 0.00001 wt. % to 0.0002 wt. % of one or more lipases or/and one or more proteases; and
   iv. 12 wt. % to 35 wt. % of one or more fats.
30. The method for preparing the baked product according to any of the preceding paragraphs, wherein the step of preparing dough comprises adding:
   i. 10 wt. % to 30 wt. % of one or more sugars,
   ii. 40 wt. % to 70% wt. % of one or more flours,
   iii. 0.1 to 2 mg enzyme protein/kg flour of one or more added lipases or/and one or more proteases; and
   iv. 12 wt. % to 35 wt. % of one or more fats.
31. The method for preparing the baked product according to any of the preceding paragraphs, wherein the step of preparing dough comprises adding:
   i. 10 wt. % to 30 wt. % of one or more sugars,
   ii. 40 wt. % to 70% wt. % of one or more flours,
   iii. 5 ppm to 300 ppm of one or more lipases or/and one or more proteases; and
   iv. 12 wt. % to 35 wt. % of one or more fats.
32. The method for preparing the baked product according to any of the preceding paragraphs, wherein the method further reduces sugar in the baked product compared to a baked product prepared without the one or more lipases or/and one or more proteases.
33. The method for preparing the baked product according to paragraph 24, wherein the baked product has 1 wt. % to 5 wt. % of sugar reduced when compared to a baked product prepared without the one or more lipases or/and one or more proteases.
34. The method for preparing the baked product according to any of the preceding paragraphs, wherein the baked product has at least 20 wt. % of fat reduced compared to a baked product prepared without the one or more lipases or/and one or more proteases.
35. The method for preparing the baked product according to any of the preceding paragraphs, wherein the baked product has at least 25 wt. % of fat reduced compared to a baked product prepared without the one or more lipases or/and one or more proteases.
36. The method for preparing the baked product according to any of the preceding paragraphs, wherein the step of preparing the dough further comprises adding one or more leavening agents.
37. The method for preparing the baked product according to paragraph 36, wherein the leavening agent is selected from a group consisting of sodium bicarbonate, ammonium bicarbonate, sodium acid pyrophosphate (SAPP), sodium phosphate, monocalcium phosphate, sodium aluminium sulfate, potassium bitartrate, sodium aluminium phosphate, glucono-delta-lactone and adipic acid, and combinations thereof.
38. The method for preparing the baked product according to paragraphs 36-37, wherein the dough comprises 0.3 wt. % to 3 wt. % one or more added leavening agents.
39. The method for preparing the baked product according to any of the preceding paragraphs, wherein the step of preparing the dough further comprises adding invert syrup, salted butter or unsalted butter, lecithin, milk powder, distilled mono and diglycerides (DMG), salt, liquid glucose, cheese, fresh milk, coloring agent, flavoring agent, sodium meta-bisulfate, sweetened condensed milk, spice and condiments, Glycerol monostearate (GMS), Diacetyl tartaric acid esters of mono- and diglycerides of fatty acids (DATEM) and/or water.
40. A use of one or more lipases in the production of a baked product to reduce fats and/or sugars used in preparing the baked product.
41. The use according to paragraph 40, wherein one or more properties of the baked product is maintained.
42. The use according to paragraphs 40 or 41, wherein the one or more properties is selected from a group consisting of mouthfeel, texture, taste, bite, spreadability, color-height-length, volume, moisture, strength, firmness, crunchiness, and shelf-life.
43. The use according to any one of paragraphs 40-42, wherein the baked product has at least 10 wt. % fats reduced, preferably at least 20 wt. % fats reduced, even more preferably at least 25 wt. % fats reduced compared to a baked product prepared without the one or more lipases or/and one or more proteases.
44. A baked product obtainable by the method according to any one of paragraphs 1-39 or obtained with the use according to any one of paragraphs 40-43.

### EXAMPLES

The following examples are not intended to be a detailed catalogue of all the different ways in which the present disclosure may be implemented or of all the features that may be added to the present disclosure. Subjects skilled in the art will appreciate that numerous variations and additions to the various embodiments may be made without departing from the present disclosure. Hence, the following descriptions are intended to illustrate some particular embodiments of the invention and not to exhaustively specify all permutations, combinations and variations thereof.

Unless otherwise indicated, the percentages set forth in the following examples are by weight, based upon the total weight of the composition.

### Material and Methods

The experiments were performed in Denmark with standard cookie making ingredients in Denmark. For preparing the cookies, standard ingredients and the standard procedure were used which is listed below in Example 1.

Enzymes used in the trials:

| Sr No | Enzymes | SEQ ID NO | Organism |
|---|---|---|---|
| 1 | Lipase | SEQ ID NO: 1 | Thermomyces lanuginosus |
| 2 | Phospholipase 1 | SEQ ID NO: 2 | Fusarium oxysporum |
| 3 | Phospholipase 2 | SEQ ID NO: 3 | Thermomyces lanuginosus |
| 4 | Phospholipase 3 | SEQ ID NO: 4 | Thermomyces lanuginosus |
| 5 | Alpha amylase | SEQ ID NO: 5 | Aspergillus oryzae |
| 6 | Protease 1 | SEQ ID NO: 6 | Bacillus amyloliquefaciens |
| 7 | Xylanase | SEQ ID NO: 7 | Thermomyces lanuginosus |
| 8 | Protease 2 | SEQ ID NO: 8 | Nocardiopsis prasina |
| 9 | Protease 3 | SEQ ID NO: 9 | Bacillus licheniformis |
| 10 | Protease 4 | SEQ ID NO: 10 | Fusarium oxysporum |
| 11 | Protease 5 | SEQ ID NO: 11 | Aspergillus oryzae |
| 12 | Protease 6 | SEQ ID NO: 12 | Aspergillus oryzae |

| Sr No | Protease blend | Enzymes |
|---|---|---|
| 1 | Blend 1 | Protease 1 and Protease 2 |
| 2 | Blend 2 | Protease 1 and Protease 3 |
| 3 | Blend 3 | Several exopeptidases and endoproteases: |
| | | Fermentation of Aspergillus oryzae |
| 4 | Blend 4 | Protease 5 and Protease 6 |

### Example 1—Process Flow of Preparing a Butter Cookie

### 1. Creaming:

Rapeseed oil, invert syrup, salted butter, lecithin, distilled mono and diglycerides (DMG) Paste, and flavor was weighed, added in a mixing bowl and mixed at medium speed for 2 minutes. Sugar & skimmed milk powder (SMP) was added to the mixing bowl and mixed at medium speed for 3 minutes. Salt, sodium bicarbonate and ammonium bicarbonate were dissolved in water and added to the mixing bowl. The ingredients in the mixing bowl were mixed at medium speed for 5 minutes.

### 2. Mixing:

Wheat flour was added, and the ingredients were mixed for 5-6 minutes for appropriate dough consistency. Water was added as per the requirement to adjust dough consistency.

### 3. Temperature:

The temperature of the dough was maintained at 23-25 degree Celsius (C)

### 4. Moulding/Sheeting:

The dough was moulded in butter cookies moulder and was sheeted in dough sheeter to a thickness of 3.5 millimeter (mm)

### 5. Baking:

The moulded and sheeted dough was baked at temperature of 235° C. for 6-7 minutes.

### 6. Cooling and Packing:

The cookies were cooled for 1.5 times of baking time and packed in aluminium foil.

### Example 2—Lipases Screening

Trials were performed with 2 types of lipases for 20% fat reduction.
1. Lipase-1,3 specific lipase (SEQ ID NO:1) which acts only on triglycerides
2. Phospholipases: Phospholipase 1 (SEQ ID NO:2), Phospholipase 2 (SEQ ID NO:3) and Phospholipase 3 (SEQ ID NO:4) which acts on triglycerides as well as polar lipids.

The lipase was added with the wheat flour during the mixing step of the process in the Example 1.

TABLE 1
Height factor of cookies using different lipases:

| | | 20% Fat | | Phospho- | Phospho- | Phospho- |
|---|---|---|---|---|---|---|
| Parameters | Control | Reduction | Lipase | lipase 1 | lipase 2 | lipase 3 |
| Enzyme dosage in ppm | 0 | 0 | 10 | 100 | 50 | 50 |
| Height factor of cookie | 2.08 | 2.15 | 2.18 | 2.12 | 2.16 | 2.07 |

TABLE 2
Stack height ranking of cookies based on enzyme dosage

| | Stack Height | Enzyme Dosage in parts |
|---|---|---|
| Rank | Ranking | per million (ppm) |
| 1^{st} | Lipase | 10 ppm |
| 2^{nd} | Phospholipase 1 | 100 ppm |
| 3^{rd} | Phospholipase 2 | 50 ppm |

Table 1 and Table 2 shows that 10 ppm of lipase (SEQ ID NO: 1) showed better performance in stack height of the cookies when compared to phospholipases (SEQ ID NO:2, SEQ ID NO:3 and SEQ ID NO:4).

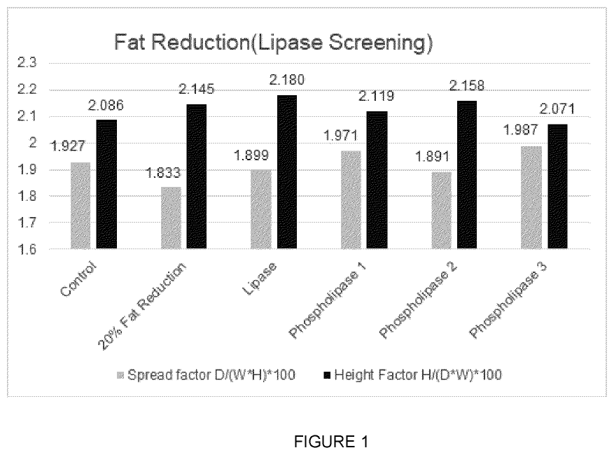

The sensory attributes of cookies baked using lipase scored higher when compared to cookies baked using phospholipases. FIG. 1 shows that lipase provides similar or better results with very low dosage as low as 10 ppm compared to phospholipases. The spread factor and height factor of the cookies with 20% reduced fat and 10 ppm of lipase are similar or more compared to control cookies and cookies baked using 50 ppm or more of phospholipases. Thus, using lipase is a cost-effective approach for baking cookies.

### Example 3—Process Flow of Preparing a Butter Cookie with 10-20% Fat Reduction

Butter cookies were prepared using the process steps as defined in Example 1. The amount of ingredients used in the process of preparing butter cookies are mentioned in Table 3 (10% fat reduction) and Table 4 (20% fat reduction).

TABLE 3
Ingredients for butter cookies with 10% fat reduction

| | Positive | Negative | Trial with lipase |
|---|---|---|---|
| Ingredient | control | control | (SEQ ID NO: 1) |
| WHEAT FLOUR | 100.00 | 103.81 | 103.81 |
| SUGAR | 35.00 | 35.00 | 35.00 |
| INVERT SYRUP | 3.08 | 3.08 | 3.08 |
| SALTED BUTTER | 3.46 | 3.46 | 3.46 |
| RAPESEED OIL | 33.37 | 30.02 | 30.02 |
| LECITHIN | 0.50 | 0.50 | 0.50 |
| SMP(SKIMMED | 3.00 | 3.00 | 3.00 |
| MILK POWDER) | | | |
| DMG PASTE | 2.25 | 2.25 | 2.25 |
| SALT | 0.90 | 0.90 | 0.90 |
| SODIUM BICARBONATE | 0.60 | 0.77 | 0.77 |
| AMMONIUM BICARBONATE | 1.20 | 1.20 | 1.20 |
| SAPP | | 0.06 | 0.06 |
| WATER | 10.00 | 12.00 | 12.00 |
| Lipase TREATMENT | | | |
| SEQ ID NO: 1 | | | 30 ppm |

TABLE 4
Ingredients for butter cookies with 20% fat reduction

| | Positive | Negative | Trial with lipase |
|---|---|---|---|
| Ingredient | control | control | (SEQ ID NO: 1) |
| WHEAT FLOUR | 100.00 | 108.00 | 108.00 |
| SUGAR | 35.00 | 34.23 | 34.23 |
| INVERT SYRUP | 3.08 | 3.08 | 3.08 |
| SALTED BUTTER | 3.46 | 3.46 | 3.46 |
| RAPESEED OIL | 33.37 | 26.56 | 26.56 |
| LECITHIN | 0.50 | 0.50 | 0.50 |
| SMP(SKIMMED | 3.00 | 3.00 | 3.00 |
| MILK POWDER) | | | |
| DMG PASTE | 2.25 | 2.25 | 2.25 |
| SAPP | | 0.10 | 0.10 |
| DATEM | | 0.010 | 0.010 |
| SALT | 0.90 | 0.90 | 0.90 |
| SODIUM BICARBONATE | 0.60 | 0.85 | 0.85 |
| AMMONIUM BICARBONATE | 1.20 | 1.35 | 1.35 |
| WATER | 10.00 | 15.00 | 15.00 |
| Lipase TREATMENT | | | |
| SEQ ID NO: 1 | | | 50 ppm |

### 1. Creaming:

Three samples were prepared: a positive control, a negative control and a trial with lipase (SEQ ID NO: 1).

### 2. Mixing:

Wheat flour was added in each of the three samples. Lipase (SEQ ID NO: 1) was added only in the sample—a trial with lipase. There was no need of resting time for dough.

### 3. Temperature:

The temperature of the dough was maintained at 23-25 degree Celsius (° C.)

### 4. Moulding/Sheeting:

The dough was moulded in butter cookies moulder and was sheeted in dough sheeter to a thickness of 3.5 millimeter (mm)

TABLE 5
Dough property of butter cookies with 10% fat reduction

| | Positive | Negative | Trial with |
|---|---|---|---|
| Dough property | control | control | enzyme |
| Dough PH | 8.2 | 8.2 | 8.3 |
| Dough Texture | 5 | 4 (dry and | 5.5 much |
| | | less smooth) | better texture |
| Dough Temperature | 24 | 25 | 24.5 |
| Dough Sheeting | 5 | 4 | 6 |

TABLE 6
Dough property of butter cookies with 20% fat reduction

| | Positive | Negative | Trial with |
|---|---|---|---|
| Dough property | control | control | enzyme |
| Dough PH | 7 | 8.05 | 8 |
| Dough Texture | 5 plastic | 4 less smooth | 4.5 much closer |
| | dough | and plastic, | to the control |
| | | less short | with less oil |
| | | dough | oozing |
| Dough Temperature | 23 | 24 | 23 |
| Dough Sheeting | 5 | 6 | 6 |

The dough properties of the trial with lipase sample were similar or improved compared to the positive control sample. The trial dough with lipase was better than the control dough in machinability at 10 and 20% fat reduction, whereas the fat reduced dough without lipase (negative control) was very dry and rough during sheeting/molding process. Thus, the lipase demonstrates the emulsification activity in wheat flour for fat reduction.

### 5. Baking:

The sheeted and moulded dough was baked at temperature of 235° C. for 6-7 minutes.

### 6. Cooling and Packing:

The cookies were cooled for 1.5 times of baking time and packed in aluminium foil.

TABLE 7
Dimensions of butter cookies with 10% fat reduction

| | Positive | Negative | Trial with |
|---|---|---|---|
| Dimensions | control | control | enzyme |
| Weight of 10 Cookies (W) in g | 62.00 | 62.20 | 57.00 |
| Stack Height of 10 Cookies(T) | 43.00 | 44.00 | 43.00 |
| in mm (PIs take photos of | | | |
| Biscuits by stacking 10 no) | | | |
| Average Length of a cookies | 56.00 | 55.00 | 56.00 |
| (L) (mm) (PIs take photo of | | | |
| Biscuit front side) | | | |
| Average width of a cookies | 56.00 | 56.00 | 58.00 |
| (W1) (mm) | | | |
| Volume | 22.47 | 22.59 | 23.28 |
| Density | 0.46 | 0.46 | 0.41 |
| Spread factor D/(W*H)*100 | 2.10 | 2.01 | 2.28 |
| Height Factor H/(D*W)*100 | 1.24 | 1.29 | 1.35 |

TABLE 8
Dimensions of butter cookies with 20% fat reduction

| | Positive | Negative | Trial |
|---|---|---|---|
| Dimensions | control | control | with enzyme |
| Weight of 10 Cookies (W) in g | 60.00 | 61.40 | 59.00 |
| Stack Height of 10 Cookies(T) in | 43.00 | 44.00 | 43.00 |
| mm (Pls take photos of Biscuits by | | | |
| stacking 10 no) | | | |
| Average Length of a cookies (L) | 56.00 | 55.00 | 56.00 |
| (mm) (Pls take photo of | | | |
| Biscuit front side) | | | |
| Average width of a cookies (W1) | 56.00 | 56.00 | 58.00 |
| (mm) | | | |
| Volume | 22.47 | 22.59 | 23.28 |
| Density | 0.44 | 0.45 | 0.42 |
| Spread factor D/(W*H)*100 | 2.17 | 2.04 | 2.21 |
| Height Factor H/(D*W)*100 | 1.28 | 1.30 | 1.30 |

Dimensions of the butter cookies of the sample-trial with lipase were similar or improved compared to the butter cookies of the positive control samples.

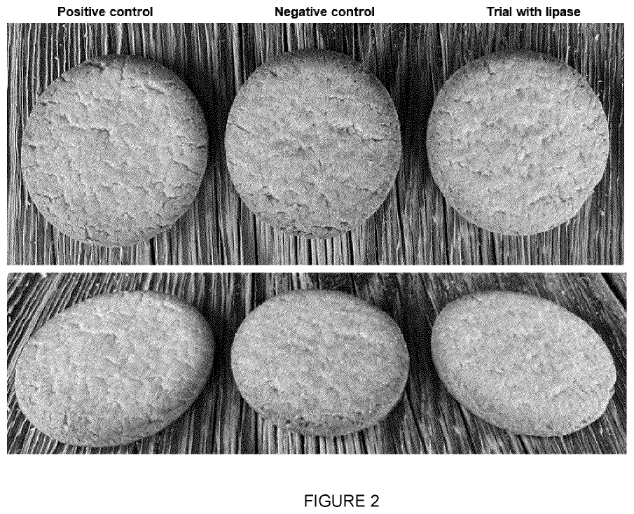

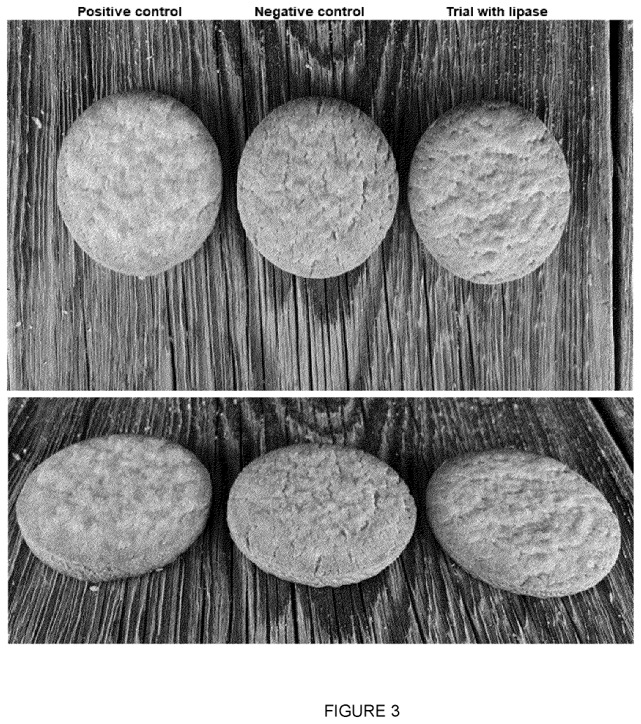

FIGS. 2 and 3 shows the positive control and the trial with lipase samples have similar texture. Thus, reduction of 10% and 20% fat in the butter cookies baking process with lipase does not compromise with the texture of butter cookies as shown in FIGS. 2 and 3.

The trial cookies with lipase shows significant increase in the stack height of the cookies in both 10% & 20% fat reduction when compares to positive control & negative control (fat reduced without lipase). The density of the trial cookies with lipase was also lesser than the controls.

With higher dosages of lipase, sugar can also be reduced in the cookies as the emulsification property of lipases increases the sugar perception in the cookies. Thus, 2% sugar was reduced and replaced with wheat flour along with 20% fat reduction at 50 ppm dosage of lipase.

### Example 4—Triangle Test-1

Total of 15 panelists was tasters for the triangle test. Three samples (two same samples and one different sample) were presented simultaneously to each panelist who is then required to identify the one that is different from the other two. Following are the six ways in which samples were presented to the panelists and each sample is coded with 3-digit number.

| | Codes | Description |
|---|---|---|
| 1 | 630, 815 | Control-standard recipe |
| 2 | 731, 324 | 10% fat reduction + Enzyme |

| | Codes | Description |
|---|---|---|
| 1 | 254, 375 | 20% fat reduction + Enzyme |
| 2 | 603, 514 | Control-standard recipe |

The panelists were requested to identify the code on the scorecard representative of the odd sample. This method requires the panelist to make a choice among the samples. Interpretation is based on the minimum number of correct responses required for significance at a predetermined significance level, given the total number of responses received. The objective was to find out the odd samples in triangle test.

TABLE 9
Triangle test results for 10% fat reduction
10% Fat reduction

| Total no of | No of peoples identified | | |
|---|---|---|---|
| sensory members | the samples correctly | | |
| 15 | 9 | | |
| Identified parameters | Texture | Flavor | Sweetness |
| Numbers | 2 | 4 | 3 |
| Comments | On positive note | Flavor of | Control is less |
| | (Lighter than control, | control is | in sweetness |
| | control is harder) | not balanced | |

TABLE 10
Triangle test results for 20% fat reduction
20% Fat reduction

| Total no of | No of peoples identified | | |
|---|---|---|---|
| sensory members | the samples correctly | | |
| 15 | 12 | | |
| Identified | Texture | Flavor | Sweetness |
| parameters | | | |
| Numbers | 3 | 7 | 2 |
| Comments | On positive | Flavor of | M1 & M2: |
| | note (Lighter | control is | Control is |
| | than control) | higher than trial | Sweeter than Trial |

None of the panelists found or observed the hardness in the texture of the cookies due to fat reduction with corresponding increase in wheat flour percentage in the sample-trial with lipase. Thus, the lipase maintains the texture of the cookies after reducing 10% & 20% of fat while baking the cookies.

The panelists felt that flavors/aroma in control samples were not balanced while flavors/aroma of the trial were well rounded off/balanced.

For 10% fat reduction, few panelists observed sweetness of trial samples slightly higher than the control, this is due to the emulsification property of lipase, and which is as a positive attribute as increase in sweetness also improves the mouthfeel and over all acceptability of the cookies.

For 20% fat reduction, 2% sugar reduction and wheat flour replacement, few panelists ( 2/15) has observed that control samples sweetness was slightly higher than the trial. Thus, lipase also supports in sugar reduction along with fat reduction at high dosages.

### Example 5—Screening of Other Enzymes Along with Lipase for 25% Fat and 2% Sugar Reduction in Butter Cookies

Following trials in Table 11 were done to evaluate the synergetic effects of other enzymes along with lipase

TABLE 11
Trial to evaluate synergy between other enzymes and lipase

| | Enzymes dosage | | Positive | | | | |
|---|---|---|---|---|---|---|---|
| | in ppm | Unit | Control | Trial 1 | Trial 2 | Trial 3 | Trial 4 |
| | Lipase | ppm | | 50 | 50 | 50 | 50 |
| | Alpha amylase | ppm | | 25 | 50 | 0 | 50 |
| | Protease 1 | ppm | | 6 | 6 | 6 | 6 |
| | Xylanase | ppm | | | | | 50 |
| | | | Control | Trial 1 | Trial 2 | Trial 3 | Trial 4 |
| | Dough pH | | 8.64 | 8.59 | 8.56 | 8.61 | 8.63 |
| | Dough Temperature | ° C. | 23 | 23 | 23 | 23 | 23 |
| | Sheeting Remarks | | 5.0 | 5.0 | 5.0 | 5.0 | 5.0 |
| | Planetary | min | 2 + 4 | 2 + 5 | 2 + 6 | 2 + 7 | 2 + 8 |
| | Mixing Profile | | | | | | |
| | High Speed | min | | | | | |
| | Mixing Profile | | | | | | |
| | Resting time | min | | | | | |
| | Sheeting thickness | mm | 5 | 5 | 5 | 5 | 5 |
| | Baking Profile | min | 240/7 min | 240/7 min | 240/7 min | 240/7 min | 240/7 min |
| | (180/180° C.) | | | | | | |
| | Product Dimensions | | | | | | |
| W | Weight of 6 | g | 44.09 | 43.22 | 43.21 | 43.33 | 43.68 |
| | Cookies | | | | | | |
| T | Stack Height of 6 | mm | 50.71 | 51.31 | 51.32 | 51.59 | 51.67 |
| | Cookies | | | | | | |
| D | Average Diameter | mm | 50.08 | 47.94 | 47.66 | 48.03 | 47.74 |
| | of a Cookie | | | | | | |
| V = 3.14*(D²/4) * | Calculated Volume | cm³ | 16.64 | 15.43 | 15.25 | 15.57 | 15.40 |
| (T/6) | | | | | | | |
| (W/6)/V | Calculated Density | g/cm³ | 0.44 | 0.47 | 0.47 | 0.46 | 0.47 |
| D/W | Spread | mm/g | 1.14 | 1.11 | 1.10 | 1.11 | 1.09 |
| T/W | Stack Ratio | mm/g | 1.15 | 1.19 | 1.19 | 1.19 | 1.18 |
| D/(W*T) *100 | Spread factor | g⁻¹ | 2.24 | 2.16 | 2.15 | 2.15 | 2.12 |
| T/(D*W) *100 | Height Factor | g⁻¹ | 2.30 | 2.48 | 2.49 | 2.48 | 2.48 |

Cookie samples with the combination of lipase and protease 1 had similar texture as of the positive control sample with 25% fat reduction, hence the combination was taken forward for further trials.

### Example 6—Process Flow of Preparing a Butter Cookie with 25% Fat Reduction

Butter cookies were prepared using the process steps as defined in Example 1. The amount of ingredients used in the process of preparing butter cookies are mentioned in Table 12 (25% fat reduction).

TABLE 12
Ingredients for butter cookies with 25% fat & 2%
Sugar reduction reduction

| | Positive | Trial | Trial with lipase |
|---|---|---|---|
| Ingredient % | control | with lipase | and protease 1 |
| Wheat flour | 58.41 | 63.85 | 63.85 |
| Sugar | 20.44 | 20.00 | 20.00 |
| Invert syrup | 1.80 | 1.80 | 1.80 |
| Palmoil | 22.01 | 17.52 | 17.52 |
| Lecithin | 0.29 | 0.29 | 0.29 |
| Smp | 1.75 | 1.75 | 1.75 |
| (skimmed milk | | | |
| powder) | | | |
| Dmg | 0.29 | 0.29 | 0.29 |
| Salt | 0.61 | 0.61 | 0.61 |
| Sodium bicarbonate | 0.35 | 0.58 | 0.58 |
| Ammonium | 0.70 | 0.97 | 0.97 |
| bicarbonate | | | |
| Butter flavor | 0.12 | 0.20 | 0.20 |
| Sapp | | 0.06 | 0.06 |
| Water | 5.85 | 9.00 | 9.00 |
| Enzyme treatment | | | |
| Lipase @ 60 ppm | | 0.00383 | |
| Lipase @ 50 ppm | | | 0.0032 |
| Protease 1 @ 8 ppm | | | 0.00052 |

### 1. Creaming:

Three samples were prepared: a positive control, a trail with lipase, and a trial with lipase and protease 1.

### 2. Mixing:

Wheat flour was added in each of the three samples. Lipase was added only in the sample—a trial with lipase. Lipase and Protease 1 was added only in the sample—a trial with lipase and protease 1. There was no need of resting time for dough.

### 3. Temperature:

The temperature of the dough was maintained at 23-25 degree Celsius (° C.)

### 4. Moulding/Sheeting:

The dough was moulded in butter cookies moulder and was sheeted in dough sheeter to a thickness of 3.5 millimeter (mm)

TABLE 13
Dough property of butter cookies with 25% fat reduction

| | Positive | Trial with lipase |
|---|---|---|
| Dough Property | Control | and protease 1 |
| Dough PH | 8.2 | 8.3 |
| Dough Texture | 5 | 6 (Soft) |
| Dough Temperature | 24 | 24 |
| Dough Sheeting | 5 | 6 (Soft) |

The dough properties of the trial with lipase and protease 1 sample were similar or improved compared to the positive control sample. Thus, the lipase and protease 1 demonstrates the emulsification activity in wheat flour for fat reduction.

### 5. Baking:

The sheeted and moulded dough was baked at temperature of 235° C. for 6-7 minutes.

### 6. Cooling and Packing:

The cookies were cooled for 1.5 times of baking time and packed in aluminium foil.

TABLE 14-A
Dimensions of butter cookies with 25% fat reduction

| Lipase | Positive | 60 PPM Trial |
|---|---|---|
| Biscuit dimensions | control | with lipase |
| Weight of 6 Cookies (W) in g | 46.2 | 45.9 |
| Stack Height of 6 Cookies(T) in mm | 45.305 | 47.32 |
| Average Lenth of a cookies (L) (mm) | 54.65 | 55.26 |
| Average width of a cookies (W1) (mm) | 54.33 | 53.70 |
| Calculated Volume | 22.42 | 23.40 |
| Calculated Density | 0.343 | 0.327 |
| Spread (L + W1)/W | 2.36 | 2.38 |
| Spread factor D/(W*H)*100 | 5.21 | 5.02 |
| Height Factor H/(D*W)*100 | 0.90 | 0.95 |
| Resting Time | 10 min | 10 min |
| Dough Temperature | 22.5 | 23 |
| Sheeting | 5 | 5.5 |
| Sheeting Remarks | Soft and | Soft and |
| | Easy to | Easy to |
| | process | process |

In 25% fat reduction with lipase (60 ppm) dosage, there is a drastic reduction in stack height. The trial sample with lipase (60 ppm) was having the harder texture and floury mouthfeel than positive control samples.

The shrinkage of cookies and harder texture of cookies made it clear that when the fat is reduced at higher percentage, dough relaxation is required. To overcome the shrinkage and harder texture of cookies, an additional enzyme (protease 1) was used to achieve the texture similar to that of positive control.

TABLE 14-B
Dimensions of butter cookies with 25% fat reduction

| | | Trial with |
|---|---|---|
| | Positive | lipase and |
| Biscuit Dimensions | Control | protease 1 |
| Weight of 6 Biscuits (W) in g | 39.68 | 40.48 |
| Weight of 1 biscuit-gm | 6.61 | 6.75 |
| Stack Height of 6 Biscuits (T) in mm | 37.76 | 40.87 |
| Stack height of 1 biscuit-cm | 0.63 | 0.68 |
| Avg.diameter of 1 Biscuits (D) (mm) | 47.47 | 50.57 |
| Día of 1 biscuit in (cm) | 4.75 | 5.06 |
| Radius of 1 Biscuit (R) in cm | 2.37 | 2.53 |
| Calculated Volume (cm³) | 11.13 | 13.67 |
| Calculated Density (g/cm³) | 0.59 | 0.49 |
| Spread D/W | 1.20 | 1.25 |
| Spread factor D/(W*H)*100 | 114.063 | 110.040 |
| Height Factor H/(D*W)*100 | 2.01 | 2.00 |
| H/W | 0.95 | 1.01 |

Dimensions of the butter cookies of the sample-trial with lipase and protease 1 were similar or improved compared to the butter cookies of the positive control samples.

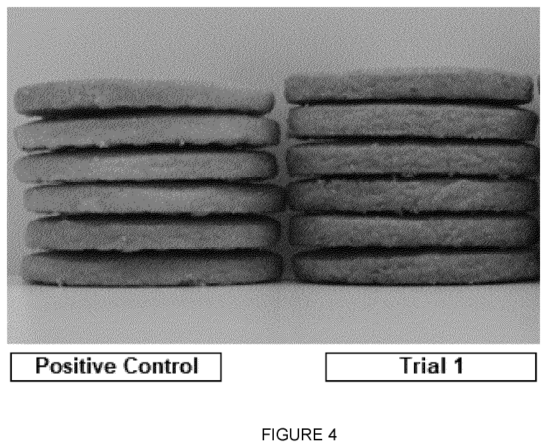

FIG. 4 shows the positive control and the trial with lipase and protease 1 samples have similar texture. Thus, reduction of 25% fat in the butter cookies baking process with lipase and protease 1 does not compromise with the texture of butter cookies as shown in FIG. 4. The trial sample also has slightly increased stack height over the positive control.

The trial cookies with lipase and protease 1 shows significant increase in the stack height of the cookies in 25% fat reduction when compares to positive control. The density of the trial cookies with lipase and protease 1 was also lesser than the positive control.

With higher dosages of lipase and protease 1, sugar can also be reduced in the cookies as the emulsification property of lipase and protease 1 increases the sugar perception in the cookies. Thus, 2% sugar was reduced and replaced with wheat flour along with 25% fat reduction at 50 ppm dosage of lipase and 8 ppm of protease 1.

### Example 7—Triangle Test 2

Total of 20 panelists was tasters for the triangle test. The triangle test was performed same as in Example 4 with butter cookies samples of Example 6.

TABLE 15
Triangle test results for 25% fat reduction
25% Fat reduction

| Total no of sensory | No of peoples identified | | |
|---|---|---|---|
| members | the samples correctly | | |
| 20 | 13 | | |
| Identified | Texture | Flavor | Sweetness |
| parameters | | | |
| Numbers | 11 | 1 | 1 |
| Comments | On positive note | Flavor of | Control |
| | (Trial is Lighter | control | is more |
| | than control, | is balanced | in sweetness |
| | control is harder) | | |

None of the panelists found or observed the hardness in the texture of the cookies due to fat reduction with corresponding increase in wheat flour percentage in the sample-trial with lipase and protease 1. Most panelists preferred the trials samples against the control due to the improved texture.

### Example 8—Process Flow of Preparing a Laminated/Hard Dough Variant of Biscuits

### 1. Creaming:

Fat, invert syrup, glycerol monostearate (GMS), DATEM, flavor was weighed, added in a mixing bowl and mixed at medium speed for 2 minutes. Sugar & skimmed milk powder (SMP) was added to the mixing bowl and mixed at medium speed for 3 minutes. Salt, sodium bicarbonate and ammonium bicarbonate were dissolved in water and added to the mixing bowl. The ingredients in the mixing bowl were mixed at medium speed for 5 minutes.

### 2. Mixing:

Wheat flour was added in the mixing bowl. SMBS was added in dissolved form in with water to the mixing bowl. The ingredients were mixed for 5-6 minutes for appropriate dough consistency. Water was added as per the requirement to adjust dough consistency.

### 3. Temperature:

The temperature of the dough was maintained at 40-42 degree Celsius (° C.)

### 4. Resting Time

The dough was rested for 20 minutes.

### 5. Sheeting:

The dough was laminated after resting time in a sheeter and the dough sheet is folded. The process of lamination and folding is repeated for 6 folds. The thickness of the final sheet after lamination is 2 millimeter (mm)

### 6. Cutting:

The laminated dough sheet was cut with teflon cutter which has dhoker pin holes.

### Baking: 7.

After cutting, the dough sheet was baked at temperature of 270° C. for 5-6 minutes.

### 8. Cooling and Packing:

The cookies were cooled for 1.5 times of baking time and packed in aluminium foil.

### Example 9—Lipase for 10% Fat Reduction in Laminated/Hard Dough Variant of Biscuits

Laminated/hard dough variant of cookies were prepared using the process steps as defined in Example 8. Trials were performed with only lipase for fat reduction of laminated/hard dough variant of biscuits. Initial trials were designed for 10% fat reduction in laminated/hard dough variant of biscuits with only lipase at 30 ppm

TABLE 16
Dough properties and biscuit dimensions using only lipase in
laminated/hard dough variant of biscuits with 10% fat reduction

| | | 30.000 |
|---|---|---|
| Lipase (in ppm) | Positive Control | Trial with lipase |
| Dough PH | 8.24 | 8.33 |
| Resting Time | 20 min | 20 min |
| Baking time | 7 min | 7 min |
| Dough Temp after Mixing | 40.2 | 40.5 |
| Sheeting | 5 | 5 |
| Sheeting Remarks | Easy to Process | Easy to Process |
| Biscuit Dimensions | Positive Control | Trial with lipase |
| Weight of 10 Biscuits (W) in g | 82.17 | 82.96 |
| Weight of 1 biscuit-gm | 8.22 | 8.30 |
| Stack Height of 10 Biscuits (T) in mm | 63.91 | 57.30 |
| Stack height of 1 biscuit-cm | 0.64 | 0.57 |
| Avg.diameter of 10 Biscuits (D) (mm) | 63.95 | 62.51 |
| Día of 1 biscuit in (cm) | 6.39 | 6.25 |
| Radius of 1 Biscuit (R) in cm | 3.20 | 3.13 |
| Calculated Volume (cm³) | 20.53 | 17.59 |
| Calculated Density (g/cm³) | 0.40 | 0.47 |
| Spread factor D/(W*H)*100 | 1.22 | 1.32 |
| Height Factor H/(D*W)*100 | 1.22 | 1.10 |

Results: Reduction in volume was observed in trial samples and density had increased. Sensorial Observations: The trial samples were dry compared to the positive control samples. The sample with fat reduction was observed to have the harder texture when compared to the positive control Sample.

### Conclusion:

The shrinkage in biscuit & harder texture, brings clarity that when the fat was reduced at higher percentage while making laminated/hard dough variant of biscuits, dough relaxation is required. Thus, there was a need to use additional enzyme (protease) to achieve the texture similar to that of the positive control.

### Example 10—Protease Screening for 10% Fat Reduction in Laminated/Hard Dough Variant of Biscuits

Laminated/hard dough variant of biscuits were prepared using the process steps as defined in Example 8. Trials were taken with following 8 types of proteases for 10% fat reduction in laminated variant/hard dough variant of biscuits.
1. Protease 1
2. Blend 1
3. Protease 2
4. Blend 2
5. Protease 3
6. Protease 4
7 Blend 3
8. Blend 4

Protease screening details below:
1. The positive control was with full fat at 10.64% on Finished Goods (FG) basis
2. The negative control was 10% fat reduction at 9.35% fat percentage on FG basis without enzymes
3. The trial was with 10% fat reduction at 9.35% fat percentage on FG basis with different protease.

TABLE 17
Dough properties and biscuit dimensions using protease 1-4

| | | Positive | Test | | | | |
|---|---|---|---|---|---|---|---|
| Enzymes (in ppm) | Unit | Control | Control | Protease 1 | Blend 1 | Protease 2 | Protease 3 |
| Protease 1 | ppm | | | 7.5 | | | |
| Blend 1 | ppm | | | | 7.5 | | |
| Protease 2 | ppm | | | | | 7.5 | |
| Protease 3 | ppm | | | | | | 100 |
| Dough pH | | 8.41 | 8.43 | 8.39 | 8.42 | 8.47 | 8.46 |
| Dough Temperature | | 41.1 | 41.2 | 43.6 | 42.8 | 42 | 43.4 |
| Dough Rating | | 5 | 4 | 6 | 5.5 | 5.5 | 4.5 |
| Dough Remarks | | Standard | Slight Dry | Softest | Slight | Slight | Soft but |
| | | | and Stiff | | softer than | softer than | Slight dry |
| | | | | | Control | Control | |
| Sheeting Rating | | 5 | 4 | 6 | 5.5 | 5.5 | 4.5 |
| Sheeting Remarks | | Standard | Slight Dry | Smoother | Smooth | Slight softer | Soft Sheet |
| | | | Sheet with | and Easy | and Easy | with No | with No |
| | | | minimal | to Process | to Process | shrinkage | shrinkage |
| | | | Shrinkage | | | observed | observed |
| Planetary | min | 1 + 1 + 1 | 1 + 1 + 1 | 1 + 1 + 1 | 1 + 1 + 1 | 1 + 1 + 1 | 1 + 1 + 1 |
| Mixing Profile | | | | | | | |
| High Speed | min | 2 + 1 | 2 + 1 | 2 + 1 | 2 + 1 | 2 + 1 | 2 + 1 |
| Mixing Profile | | | | | | | |
| Resting time | min | 20 | 20 | 20 | 20 | 20 | 20 |
| Sheeting thickness | mm | 1.9-2.1 mm | 1.9-2.1 mm | 1.9-2.1 mm | 1.9-2.1 mm | 1.9-2.1 mm | 1.9-2.1 mm |
| Baking Profile | min | 260 C./7 min | 260 C./7 min | 260 C./7 min | 260 C./7 min | 260 C./7 min | 260 C./7 min |
| (260/260 C.) | | | | | | | |
| Product Dimensions | | | | | | | |
| Weight of 6 | g | 34.18 | 34.47 | 34.82 | 34.75 | 35.09 | 35.12 |
| Biscuits | | | | | | | |
| Stack Height of 6 | mm | 31.32 | 31.63 | 33.06 | 33.43 | 31.77 | 32.60 |
| Biscuits | | | | | | | |
| Average Diameter | mm | 57.37 | 57.01 | 57.47 | 57.75 | 57.88 | 57.72 |
| of a Biscuit | | | | | | | |
| Calculated Volume | cm³ | 13.49 | 13.45 | 14.28 | 14.59 | 13.93 | 14.21 |
| Calculated Density | g/cm³ | 0.42 | 0.43 | 0.41 | 0.40 | 0.42 | 0.41 |
| Spread | mm/g | 1.68 | 1.65 | 1.65 | 1.66 | 1.65 | 1.64 |
| Stack Ratio | mm/g | 0.92 | 0.92 | 0.95 | 0.96 | 0.91 | 0.93 |
| Spread factor | g⁻¹ | 5.36 | 5.23 | 4.99 | 4.97 | 5.19 | 5.04 |
| Height Factor | g⁻¹ | 1.60 | 1.61 | 1.65 | 1.67 | 1.56 | 1.61 |
| Sensory | | | | | | | |
| 1. Appearance | | 5 | 4.50 | 4.63 | 4.88 | 4.50 | 4.50 |
| 2. Texture | | 5 | 3.88 | 5.50 | 4.50 | 4.38 | 4.17 |
| 3. Mouthfeel | | 5 | 3.50 | 5.25 | 4.75 | 4.13 | 4.25 |
| 4. Flavor | | 5 | 4.00 | 5.13 | 4.13 | 4.75 | 4.25 |
| 5. Overall rating | | 5 | 3.75 | 5.25 | 4.25 | 4.33 | 3.75 |

TABLE 18
Dough properties and biscuit dimensions using protease 5-8

| | | Positive | | | | |
|---|---|---|---|---|---|---|
| Enzymes | Unit | Control | Blend 2 | Protease 4 | Blend 3 | Blend 4 |
| Blend 2 | ppm | | 100 | | | |
| Protease 4 | ppm | | | 30 | | |
| Blend 3 | ppm | | | | 150 | |
| Blend 4 | ppm | | | | | 150 |
| Dough pH | | 8.26 | 8.21 | 8.29 | 8.33 | 8.36 |
| Dough Temperature | ° C. | 41.1 | 39.7 | 41.7 | 42.8 | 41.7 |
| Dough Rating | | 5 | 5.5 | 7 | 6.5 | 6.5 |
| Dough Remarks | | Standard | Soft and | Softest | Soft but dry | Soft but dry |
| | | | Smooth | | | |
| Sheeting Rating | | 5 | 6 | 4.5 | 5.5 | 5.5 |
| Sheeting Remarks | | Standard | Easy, | Too Soft | Smooth but | Smooth but |
| | | | Smooth | to process | Shrinks | Shrinks |
| Planetary | min | 1 + 1 + 1 | 1 + 1 + 1 | 1 + 1 + 1 | 1 + 1 + 1 | 1 + 1 + 1 |
| Mixing Profile | | | | | | |
| High Speed | min | 2 + 1 | 2 + 1 | 2 + 1 | 2 + 1 | 2 + 1 |
| Mixing Profile | | | | | | |
| Resting time | min | 20 | 20 | 20 | 20 | 20 |
| Sheeting thickness | mm | 1.9-2.1 mm | 1.9-2.1 mm | 1.9-2.1 mm | 1.9-2.1 mm | 1.9-2.1 mm |
| Baking Profile | min | 260 C./7 min | 260 C./7 min | 260 C./7 min | 260 C./7 min | 260 C./7 min |
| (180/180° C.) | | | | | | |
| Product Dimensions | Unit | Control | Trial 5 | Trial 6 | Trial 8 | Trial 9 |
| Weight of 6 | g | 35.44 | 34.75 | 34.56 | 35.41 | 35.58 |
| Biscuits | | | | | | |
| Stack Height of 6 | mm | 33.41 | 35.74 | 35.49 | 35.20 | 35.85 |
| Biscuits | | | | | | |
| Average Diameter | mm | 57.92 | 58.75 | 59.26 | 57.87 | 57.86 |
| of a Biscuit | | | | | | |
| Calculated Volume | cm³ | 14.66 | 16.14 | 16.31 | 15.42 | 15.70 |
| Calculated Density | g/cm³ | 0.40 | 0.36 | 0.35 | 0.38 | 0.38 |
| Spread | mm/g | 1.63 | 1.69 | 1.71 | 1.63 | 1.63 |
| Stack Ratio | mm/g | 0.94 | 1.03 | 1.03 | 0.99 | 1.01 |
| Spread factor | g⁻¹ | 4.89 | 4.73 | 4.83 | 4.64 | 4.54 |
| Height Factor | g⁻¹ | 1.63 | 1.75 | 1.73 | 1.72 | 1.74 |
| Sensory | | | | | | |
| 1. Appearance | | 5.0 | 4.8 | 4.5 | 3.8 | 3.8 |
| 2. Texture | | 5.0 | 5.2 | 5.0 | 4.5 | 4.0 |
| 3. Mouthfeel | | 5.0 | 4.8 | 4.3 | 4.5 | 4.3 |
| 4. Flavor | | 5.0 | 4.7 | 4.3 | 4.7 | 4.7 |
| 5. Overall rating | | 5.0 | 4.8 | 4.5 | 4.3 | 4.3 |

All the proteases have same or better dough properties, biscuit dimensions, sensorial properties compared to the positive control. Biscuit with protease 1 had better dough properties, biscuit dimensions, sensorial properties when compared to other type of proteases. Protease 1 worked at very low dosage, thus protease 1 was shortlisted for further trials with lipase.

### Example 11—Process Flow of Preparing Laminated/Hard Dough Variant of Biscuits with 10% Fat Reduction

Laminated/hard dough variant of biscuits were prepared using the process steps as defined in Example 8. Trials were performed with lipase & protease 1 with 10% Fat reduction.

TABLE 19
Dough properties and biscuit dimensions using lipase and protease 1 with 10% fat reduction

| | | | Positive | Negative | | | | |
|---|---|---|---|---|---|---|---|---|
| | | Unit | Control | control | Trial 2 | Trial 3 | Trial 4 | Trial 5 |
| | Enzymes | | | | | | | |
| | Protease 1 | ppm | | | 6 | 6 | 6 | 6 |
| | Lipase | ppm | | | | 8 | 10 | 12 |
| | Dough properties | | | | | | | |
| | Dough pH | | 8.28 | 8.28 | 8.28 | 8.28 | 8.28 | 8.28 |
| | Dough Temperature | ° C. | 40.5 | 41.2 | 41 | 40.9 | 41 | 47.9 |
| | Sheeting Remarks | | Standard | Slightly | Similar | Slightly | Slightly | Softest |
| | | | | tight dough | as of | softer than | softer than | among |
| | | | | texture | Control | Control | Control | all |
| | Planetary | min | 3 min | 3 min | 3 min | 3 min | 3 min | 3 min |
| | Mixing Profile | | | | | | | |
| | High Speed | min | 3 min | 3 min | 3 min | 3 min | 3 min | 3 min |
| | Mixing Profile | | | | | | | |
| | Resting time | min | 25 | 25 | 25 | 25 | 25 | 25 |
| | Sheeting thickness | mm | 2 mm | 2 mm | 2 mm | 2 mm | 2 mm | 2 mm |
| | Baking Profile | min | 280 | 280 | 280 | 280 | 280 | 280 |
| | Baking time | | 8 min | 8 min | 8 min | 8 min | 8 min | 8 min |
| | Biscuit Dimensions | | | | | | | |
| W | Weight of 6 | g | 41.22 | 41.22 | 41.18 | 40.90 | 40.99 | 40.70 |
| | Biscuit | | | | | | | |
| T | Stack Height of 6 | mm | 37.35 | 38.00 | 36.58 | 37.10 | 37.47 | 37.80 |
| | Biscuit | | | | | | | |
| D | Average Diameter | mm | 57.18 | 58.07 | 58.24 | 57.47 | 58.33 | 57.57 |
| | of a Biscuit | | | | | | | |
| V = 3.14*(D2/4)* | Calculated Volume | cm³ | 15.98 | 16.76 | 16.23 | 16.03 | 16.68 | 16.39 |
| (T/6) | | | | | | | | |
| (W/6)/V | Calculated Density | g/cm³ | 0.43 | 0.41 | 0.42 | 0.43 | 0.41 | 0.41 |
| D/W | Spread | mm/g | 1.39 | 1.41 | 1.41 | 1.41 | 1.42 | 1.41 |
| T/W | Stack Ratio | mm/g | 0.91 | 0.92 | 0.89 | 0.91 | 0.91 | 0.93 |
| D/(W*T)*100 | Spread factor | g⁻¹ | 3.71 | 3.71 | 3.87 | 3.79 | 3.80 | 3.74 |
| T/(D*W)*100 | Height Factor | g⁻¹ | 1.58 | 1.59 | 1.52 | 1.58 | 1.57 | 1.61 |

Results: The trials with protease 1 and lipase was observed to have better spread and stack height factor similar as of the positive control.

With protease 1 alone, similar volume and density was achieved as that of the positive control but with dry mouthfeel in sensorial properties. Thus, lipase was added to match the mouthfeel similar as that of the positive control. The mouthfeel was matched with the combination of protease 1 and lipase, as lipase enhances emulsification properties.

### Example 12—Process Flow of Preparing Laminated/Hard Dough Variant of Biscuits with 10% Fat Reduction

Laminated/hard dough variant of biscuits were prepared using the process steps as defined in Example 8. The amount of ingredients used in the process of preparing such biscuits are mentioned in Table 20 (10% fat reduction in laminated variant).

TABLE 20
Ingredients for cookies with 10% fat reduction

| | | | Trial |
|---|---|---|---|
| | Positive | Negative | with lipase |
| INGREDIENT % | control | control | and protease 1 |
| WHEAT FLOUR | 73.43 | 74.72 | 74.72 |
| SUGAR | 19.08 | 19.11 | 19.11 |
| INVERT SYRUP | 3.47 | 3.48 | 3.48 |
| PALM OIL | 10.64 | 9.53 | 9.53 |
| GMS | 0.20 | 0.13 | 0.13 |
| SMP | 1.16 | 1.16 | 1.16 |
| DATEM | 0.03 | 0.03 | 0.03 |
| SALT | 0.52 | 0.52 | 0.52 |
| SODIUM BICARBONATE | 0.38 | 0.38 | 0.38 |
| AMMONIUM BICARBONATE | 1.04 | 1.16 | 1.16 |
| MILK FLAVOR | 0.20 | 0.25 | 0.25 |
| SMBS | 0.04 | 0.04 | 0.04 |
| WATER | 16.19 | 17.38 | 17.38 |
| ENZYME TREATMENT | | | |
| Lipase @ 8 PPM | | | 0.00060 |
| Protease 1 @ 7 PPM | | | 0.00052 |

### 1. Creaming:

Three samples were prepared: a positive control, a negative control and a trial with lipase and protease 1.

### 2. Mixing:

Wheat flour was added in each of the three samples. Lipase and protease 1 were added only in the sample—a trial with lipase and protease 1.

### 3. Temperature:

The temperature of the dough was maintained at 40-42 degree Celsius (° C.). The dough for rested for 20 minutes.

### 4. Sheeting:

The dough was laminated in a sheeter and the dough sheet was folded. The process of laminating and folding was repeated with 6 folds. The thickness of the final sheet after lamination was 2 millimeters (mm)

TABLE 21
Dough properties of laminated/hard dough variant of
biscuits with 12% fat reduction with lipase

| | Positive | Negative | Trial with lipase |
|---|---|---|---|
| Dough Property | control | control | and protease 1 |
| Dough PH | 8.4 | 8.41 | 8.42 |
| Dough Texture | 5 | 4 (dry and hard) | 5.5 (Softer) |
| Dough Temperature | 40.2 | 41.6 | 41.8 |
| Dough resting time | 20 min | 20 min | 20 min |
| Dough Sheeting | 5 | 4 (dry & shrink) | 5.5(Smooth) |

The trial dough with lipase and protease 1 was better than control dough in machinability at 10% fat reduction, where as the fat reduced dough without lipase and protease 1 (negative control) was dry and shrunk during sheeting process. This demonstrates the emulsification and dough relaxation activity of lipase and protease 1 in wheat flour for fat reduction.

### 5. Cutting:

The laminated dough sheet was cut with Teflon cutter with dhoker pin holes.

### 6. Baking:

The laminated dough sheet was baked at temperature of 270° C. for 5-6 minutes.

### 7. Cooling and Packing:

The crackers were cooled for 1.5 times of baking time and packed in aluminium foil.

TABLE 22
Dimensions of laminated variant of biscuits
with 10% fat reduction

| | Positive | Test | |
|---|---|---|---|
| Biscuit Dimensions | Control | Control | Trial |
| Weight of 6 Biscuits (W) in g | 35.82 | 35.60 | 36.20 |
| Weight of 1 biscuit-gm | 5.97 | 5.93 | 6.03 |
| Stack Height of 6 Biscuits (T) in mm | 34.68 | 35.72 | 35.97 |
| Stack height of 1 biscuit-cm | 0.58 | 0.60 | 0.60 |
| Avg.diameter of 6 Biscuits (D) (mm) | 58.05 | 57.85 | 57.61 |
| Día of 1 biscuit in (cm) | 5.80 | 5.78 | 5.76 |
| Radius of 1 Biscuit (R) in cm | 2.90 | 2.89 | 2.88 |
| Calculated Volume (cm³) | 15.29 | 15.64 | 15.62 |
| Calculated Density (g/cm³) | 0.39 | 0.38 | 0.39 |
| Spread D/W | 1.62 | 1.62 | 1.59 |
| Spread factor D/(W*H)*100 | 4.67 | 4.55 | 4.42 |
| Height Factor H/(D*W)*100 | 1.67 | 1.73 | 1.72 |
| H/W | 0.97 | 1.00 | 0.99 |

Dimensions of the crackers of the sample-trial with lipase and protease 1 were similar or improved compared to the crackers of the positive control samples.

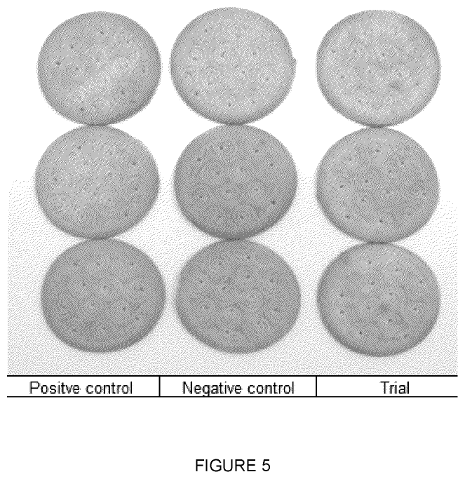

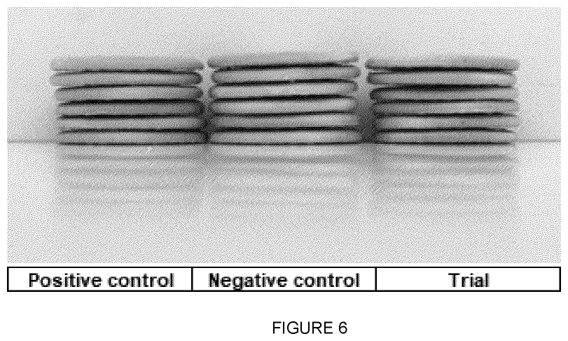

FIGS. 5 and 6 shows the positive control and the trial with lipase and protease 1 samples have similar texture. Thus, reduction of 10% fat laminated variant of the biscuits baking process with lipase and protease 1 does not compromise with the texture of crackers as shown in FIGS. 5 and 6.

The trial crackers with lipase and protease 1 shows slight increase in the stack height of the crackers in both 10% fat reduction when compares to positive control & negative control (fat reduced without lipase and protease 1). The density of the trial crackers with lipase and protease 1 was also lesser than the controls.

### Example 13—Triangle Test 3

Total of 20 panelists was tasters for the triangle test. The triangle test was performed same as in Example 4 with crackers samples of Example 8.

TABLE 23
Triangle test results for 12% fat reduction in laminated variant of biscuits
10% Fat reduction in Marie

| Total no of sensory | No of people identified the | |
|---|---|---|
| members | samples correctly | |
| 20 | 4 | |
| Identified | Texture | Sweetness |
| parameters | | |
| Numbers | 3 | 1 |
| Comments | 2 on positive note | Trial is less sweet |
| | (Lighter than control, control is harder), 1 member | |
| | has identifed the Control has light texture than trial | |

None of the panelists found or observed the hardness in the texture of the crackers due to 10% fat reduction with corresponding increase in wheat flour percentage in the sample-trial with lipase and protease 1.

1. A method for preparing a baked product comprising reduced fat, the method comprising the steps of:
a. preparing a dough by adding at least:
i. one or more sugars,
ii. one or more flours,
iii. one or more lipases or/and one or more proteases; and
iv. one or more fats;
b. moulding the dough in one or more dough molds and/or sheeting the dough in one or more dough sheeters;
C. baking the dough;
wherein the baked product has at least 10 weight percent (wt. %) fat to 25 wt. % reduced when compared to a baked product prepared without the one or more lipases or/and one or more proteases.

2. The method for preparing the baked product according to claim 1, wherein the baked product is selected from a group consisting of biscuits, cookies, laminated variant of biscuits, and crackers.

3. The method for preparing the baked product according to claim 1, wherein the dough comprises 10 wt. % to 30 wt. % one or more added sugars.

4. The method for preparing the baked product according to claim 1, wherein the flour is selected from a group consisting of wheat flour, all-purpose flour, whole wheat flour, rice flour, corn flour, millet flour, soya flour, oats flour, pastry flour, bread flour, gluten free flour, tapioca flour and self-rising flour.

5. The method for preparing the baked product according to claim 1, wherein the dough comprises 40 wt. % to 70 wt. % one or more added flours.

6. The method for preparing the baked product according to claim 1, wherein the lipase is Thermomyces lanuginosus (formerly called Humicola lanuginosus) wild type lipase.

7. The method for preparing the baked product according to claim 1, wherein the one or more lipases is a polypeptide selected from a group consisting of:
(a) a polypeptide having at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 1;
(b) a polypeptide derived from SEQ ID NO:1 by having 1-30 alterations;
(c) a polypeptide derived from the polypeptide of (a), wherein the N- and/or C-terminal end has been extended by addition of one or more amino acids; and
(d) a fragment of the polypeptide of (a).

8. The method for preparing the baked product according to claim 1, wherein the one or more lipases is a polypeptide having a sequence of SEQ ID NO: 1.

9. The method for preparing the baked product according to claim 1, wherein the one or more proteases is a polypeptide selected from a group consisting of:
(a) a polypeptide having at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 6;
(b) a polypeptide derived from SEQ ID NO:6 by having 1-30 alterations;
(c) a polypeptide derived from the polypeptide of (a), wherein the N- and/or C-terminal end has been extended by addition of one or more amino acids; and
(d) a fragment of the polypeptide of (a).

10. The method for preparing the baked product according to claim 1, wherein the one or more proteases is a polypeptide having a sequence of SEQ ID NO: 6.

11. The method for preparing the baked product according to claim 1, wherein the dough comprises 12 wt. % to 35 wt. % one or more fats.

12. The method for preparing the baked product according to claim 1, wherein the baked product has 1 wt. % to 5 wt. % of sugar reduced when compared to a baked product prepared without the one or more lipases or/and one or more proteases.

13. (canceled)

14. (canceled)

15. A baked product obtainable by the method according to claim 1.


SEQUENCE LISTING (12 sequences)

SEQ ID NO: 1 - protein, 269 aa, Thermomyces lanuginosus [sequence omitted]

SEQ ID NO: 2 - protein, 331 aa, Fusarium oxysporum
SPVALDDYVNSLEERAVGVTTTDFSNFKFYIQHGAAAYCNSEAAAGSKITCSNNGCPTVQGNGATIVTSFVGSKTGIGGYVATDSARKEIVVSFRGSINIRNWLTNLDFGQEDCSLVSGCGVHSGFQRAWNEISSQATAAVASARKANPSFNVISTGHSLGGAVAVLAAANLRVGGTPVDIYTYGSPRVGNAQLSAFVSNQAGGEYRVTHADDPVPRLPPLIFGYRHTTPEFWLSGGGGDKVDYTISDVKVCEGAANLGCNGGTLGLDIAAHLHYFQATDACNAGGFSWRRYRSAESVDKRATMTDAELEKKLNSYVQMDKEYVKNNQARS

SEQ ID NO: 3 - protein, 317 aa, Thermomyces lanuginosus
EVSQDLFNQFNLFAQYSAAAYCGKNNDAPAGTNITCTGNACPEVEKADATFLYSFEDSGVGDVTGFLALDNTNKLIVLSFRGSRSIENWIANLNFWLKKINDICSGCRGHDGFTSSWRSVADTLRQKVEDAVREHPDYRVVFTGHSLGGALATVAGADLRGNGYDIDVFSYGAPRVGNRAFAEFLTVQTGGTLYRITHTNDIVPRLPPREFGYSHSSPEYWIKSGTLVPVTRNDIVKIEGIDATGGNNQPNIPDIVAHLWYFQATDACNAGGFSWRRYRSAESVDKRATMTDAELEKKLNSYVQMDKEYVKNNQARS

SEQ ID NO: 4 - protein, 274 aa, Thermomyces lanuginosus
EVSQDLFNQFNLFAQYSAAAYCGKNNDAPAGTNITCTGNACPEVEKADATFLYSFEDSGVGDVTGFLALDNTNKLIVLSFRGSRSIENWIANLNFWLKKINDICSGCRGHDGFTSSWRSVADTLRQKVEDAVREHPDYRVVFTGHSLGGALATVAGADLRGNGYDIDVFSYGAPRVGNRAFAEFLTVQTGGTLYRITHTNDIVPRLPPREFGYSHSSPEYWIKSGTLVPVTRNDIVKIEGIDATGGNNQPNIPDIPAHLWYFQATDACNAGGFS

SEQ ID NO: 5 - protein, 478 aa, Aspergillus oryzae
ATPADWRSQSIYFLLTDRFARTDGSTTATCNTADQKYCGGTWQGIIDKLDYIQGMGFTAIWITPVTAQLPQTTAYGDAYHGYWQQDIYSLNENYGTADDLKALSSALHERGMYLMVDVVANHMGYDGAGSSVDYSVFKPFSSQDYFHPFCFIQNYEDQTQVEDCWLGDNTVSLPDLDTTKDVVKNEWYDWVGSLVSNYSIDGLRIDTVKHVQKDFWPGYNKAAGVYCIGEVLDGDPAYTCPYQNVMDGVLNYPIYYPLLNAFKSTSGSMDDLYNMINTVKSDCPDSTLLGTFVENHDNPRFASYTNDIALAKNVAAFIILNDGIPIIYAGQEQHYAGGNDPANREATWLSGYPTDSELYKLIASANAIRNYAISKDTGFVTYKNWPIYKDDTTIAMRKGTDGSQIVTILSNKGASGDSYTLSLSGAGYTAGQQLTEVIGCTTVTVGSDGNVPVPMAGGLPRVLYPTEKLAGSKICSSS

SEQ ID NO: 6 - protein, 300 aa, Bacillus amyloliquefaciens
AATTGTGTTLKGKTVSLNISSESGKYVLRDLSKPTGTQIITYDLQNREYNLPGTLVSSTTNQFTTSSQRAAVDAHYNLGKVYDYFYQKFNRNSYDNKGGKIVSSVHYGSRYNNAAWIGDQMIYGDGDGSFFSPLSGSMDVTAHEMTHGVTQETANLNYENQPGALNESFSDVFGYFNDTEDWDIGEDITVSQPALRSLSNPTKYGQPDNFKNYKNLPNTDAGDYGGVHTNSGIPNKAAYNTITKIGVNKAEQIYYRALTVYLTPSSTFKDAKAALIQSARDLYGSQDAASVEAAWNAVGL

SEQ ID NO: 7 - protein, 194 aa, Thermomyces lanuginosus
QTTPNSEGWHDGYYYSWWSDGGAQATYTNLEGGTYEISWGDGGNLVGGKGWNPGLNARAIHFEGVYQPNGNSYLAVYGWTRNPLVEYYIVENFGTYDPSSGATDLGTVECDGSIYRLGKTTRVNAPSIDGTQTFDQYWSVRQDKRTSGTVQTGCHFDAWARAGLNVNGDHYYQIVATEGYFSSGYARITVADVG

SEQ ID NO: 8 - protein, 188 aa, Nocardiopsis prasina
ADIIGGLAYTMGGRCSVGFAATNAAGQPGFVTAGHCGRVGTQVTIGNGRGVFEQSVFPGNDAAFVRGTSNFTLTNLVSRYNTGGYATVAGHNQAPIGSSVCRSGSTTGWHCGTIQARGQSVSYPEGTVTNMTRTTVCAEPGDSGGSYISGTQAQGVTSGGSGNCRTGGTTFYQEVTPMVNSWGVRLRT

SEQ ID NO: 9 - protein, 274 aa, Bacillus licheniformis
AQTVPYGIPLIKADKVQAQGFKGANVKVAVLDTGIQASHPDLNVVGGASFVAGEAYNTDGNGHGTHVAGTVAALDNTTGVLGVAPSVSLYAVKVLNSSGSGSYSGIVSGIEWATTNGMDVINMSLGGASGSTAMKQAVDNAYARGVVVVAAAGNSGSSGNTNTIGYPAKYDSVIAVGAVDSNSNRASFSSVGAELEVMAPGAGVYSTYPTNTYATLNGTSMASPHVAGAAALILSKHPNLSASQVRNRLSSTATYLGSSFYYGKGLINVEAAAQ

SEQ ID NO: 10 - protein, 224 aa, Fusarium oxysporum
IVGGTSASAGDFPFIVSISRNGGPWCGGSLLNANTVLTAAHCVSGYAQSGFQIRAGSLSRTSGGITSSLSSVRVHPSYSGNNNDLAILKLSTSIPSGGNIGYARLAASGSDPVAGSSATVAGWGATSEGGSSTPVNLLKVTVPIVSRATCRAQYGTSAITNQMFCAGVSSGGKDSCQGDSGGPIVDSSNTLIGAVSWGNGCARPNYSGVYASVGALRSFIDTYA

SEQ ID NO: 11 - protein, 512 aa, Aspergillus oryzae
TANNVTIRYKEPGAEGVCETTPGVKSYSGYVDTSPESHTFFWFFEARHNPETAPITLWLNGGPGSDSLIGLFEELGPCHVNSTFDDYINPHSWNEVSNLLFLSQPLGVGFSYSDTVDGSINPVTGVVENSSFAGVQGRYPTIDATLIDTTNLAAEAAWEILQGFLSGLPSLDSRVQSKDFSLWTESYGGHYGPAFFNHFYEQNERIANGSVNGVQLNFNSLGIINGIIDEAIQAPYYPEFAVNNTYGIKAVNETVYNYMKFANQMPNGCQDLISTCKQTNRTALADYALCAEATNMCRDNVEGPYYAFAGRGVYDIRHPYDDPTPPSYYNKFLAKDSVMDAIGVNINYTQSNNDVYYAFQQTGDFVWPNFIEDLEEILALPVRVSLIYGDADYICNWFGGQAVSLAANYSQAAQFRSAGYTPLKVNGVEYGETREYGNFSFTRVYEAGHEVPYYQPIASLQLFNRTIFGWDIAEGQKKIWPSYKTNGTATATHTQSSVPLPTATSMSSVGMA

SEQ ID NO: 12 - protein, 480 aa, Aspergillus oryzae
RALVSPDEFPEDIQLEDLLEGSQQLEDFAYAYPERNRVFGGKAHDDTVNYLYEELKKTGYYDVYKQPQVHLWSNADQTLKVGDEEIEAKTMTYSPSVEVTADVAVVKNLGCSEADYPSDVEGKVALIKRGECPFGDKSVLAAKAKAAASIVYNNVAGSMAGTLGAAQSDKGPYSAIVGISLEDGQKLIKLAEAGSVSVDLWVDSKQENRTTYNVVAQTKGGDPNNVVALGGHTDSVEAGPGINDDGSGIISNLVIAKALTQYSVKNAVRFLFWTAEEFGLLGSNYYVSHLNATELNKIRLYLNFDMIASPNYALMIYDGDGSAFNQSGPAGSAQIEKLFEDYYDSIDLPHIPTQFDGRSDYEAFILNGIPSGGLFTGAEGIMSEENASRWGGQAGVAYDANYHAAGDNMTNLNHEAFLINSKATAFAVATYANDLSSIPKRNTTSSLHRRARTMRPFGKRAPKTHAHVSGSGCWHSQVEA